(19) United States
(12) Patent Application Publication
(10) Pub. No.: US 2007/0085281 A1
(43) Pub. Date: Apr. 19, 2007

(54) Combination of cupholder and mounting means for shopping cart

(75) Inventor: Mark T. Ryan, Haskell, OK (US)

Correspondence Address: WOOD, PHILLIPS, KATZ, CLARK & MORTIMER, 500 W. MADISON STREET, SUITE 3800, CHICAGO, IL, 60661, US

(73) Assignee: Unarco Industries, Inc.

(21) Appl. No.: 11/252,935

(22) Filed: Oct. 18, 2005

(51) Int. Cl. B62D 39/00

(52) U.S. Cl. 280/33.992

(57) ABSTRACT

A cupholder is mountable to a wall of a basket of a shopping cart by an outer mounting plate, an inner mounting plate, and a fastener, which is adapted to pass though an aperture in the wall for fastening the mounting plates to each other. The aperture is one of a pattern of apertures, which are defined by substantially horizontally extending wires and by substantially vertically extending wires. The cupholder comprises a continuous wire having two lowermost portions, between and to which the outer mounting plate is mounted, two intermediate portions, which define a cup-supporting level and on which a cup-supporting plate is seated, and an uppermost portion, which is shaped to embrace a cup being held by the cupholder. The continuous wire has two lower connecting portions, each of which connects one of the lowermost portions to one of the intermediate portions, and two upper connecting portions, each of which connects one of the lowermost portions to the uppermost portion.

### TECHNICAL FIELD OF THE INVENTION

This invention pertains to a combination comprising a cupholder and means for mounting the cupholder to a wall of a basket of a shopping cart.

### BACKGROUND OF THE INVENTION

As exemplified in prior patents including, among other patents, U.S. Pat. No. 5,494,306, U.S. Pat. No. 5,938,091, U.S. Pat. No. 6,186,382, U.S. Pat. No. 6,644,524, and U.S. Pat. No. 6,832,768, it has been known to provide handles, seat bases of child seats, and other components of shopping carts with cupholders, which shoppers can use to hold cups containing coffee, soft drinks, or other beverages.

### SUMMARY OF THE INVENTION

This invention provides for a shopping cart having a basket, which has substantially vertical walls having a pattern or patterns of apertures, a combination comprising a cupholder and means for mounting the cupholder to the basket. The combination can be advantageously employed when the apertures are defined by substantially horizontally extending wires and by substantially vertically extending wires.

The mounting means comprises an outer mounting plate, which is positionable outside and against a given one of the basket walls, at a given one of the apertures, an inner mounting plate, which is positionable inside and against the same one of the basket walls, at the same one of the apertures, and a fastener, which is adapted to extend through the same one of the apertures, for fastening the outer and inner mounting plates, when so positioned, to each other, so as to mount the cupholder to the same one of the basket walls.

Preferably, at least one of the outer and inner mounting plates is adapted to project, when so positioned, into the same one of the apertures. In a preferred embodiment, the outer mounting plate is so adapted.

### BRIEF DESCRIPTION OF THE DRAWINGS

FIG. 1 is a perspective view of a cupholder and a mounting means, by which the cupholder is mounted to a wall of a basket of a shopping cart. The wall and other features of the shopping cart are illustrated, fragmentarily, in broken lines.

FIGS. 2, 3, 4, 5, and 6, on a larger scale, are, respectively, a top plan, a bottom plan, a front elevation, a rear elevation, and a side elevation of the cupholder and the mounting means. FIG. 6 is taken from the near side of the cupholder, as illustrated in FIG. 1, the far side being a mirror image of the near side.

FIG. 7, on a similar scale, is a partly exploded, perspective view of the cupholder and the mounting means. A portion of the wall of the shopping cart is illustrated, fragmentarily, in broken lines.

### DETAILED DESCRIPTION OF THE ILLUSTRATED EMBODIMENT

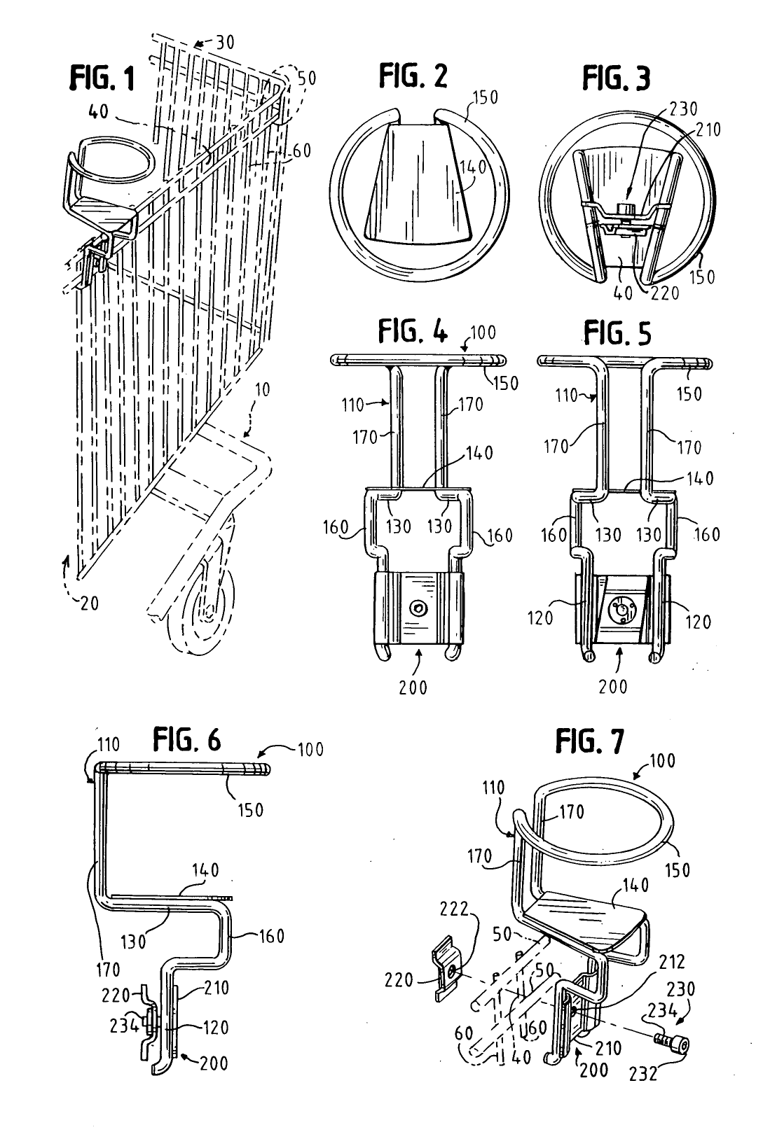

As illustrated in FIG. 1, a cupholder 100 is mounted to a shopping cart 10 by a mounting means 200, which is employed to mount the cupholder 100 to a side wall 20 of a basket 30 of the shopping cart 10. The side wall 20 of the basket 30 of the shopping cart 10 has a pattern of substantially rectangular apertures 40, which are defined by substantially horizontally extending wires 50 and by substantially vertically extending wires 60.

The mounting means 200 comprises an outer mounting plate 210, which is positionable outside and against the side wall 20, at a given aperture 40, an inner mounting plate 220, which is positionable inside and against the side wall 20, at the same aperture 40, and a fastener 230, which has a head 232 and a threaded shank 234. The threaded shank 234 is adapted to extend through a hole 212 in the outer mounting plate 210, through the same aperture 40, into a threaded hole 222 in the inner mounting plate 220, for fastening the outer and inner mounting plates 210, 220, when so positioned, to each other, so as to mount the cupholder 200 to the side wall 20. Both of the outer and inner mounting plates 210, 220, are adapted to project, when so positioned, into the given aperture 40. Essentially, the inner mounting plate 220 functions as a threaded nut, which coacts with the threaded shank 234 of the fastener 230.

The cupholder 100 comprises a continuous wire 110 having two lowermost portions 120, which extend downwardly, at which the continuous wire 110 terminated, and between and to which the outer mounting plate 210 is welded or is mounted otherwise. Moreover, the continuous wire 110 has two intermediate portions 130, which extend horizontally, which define a cup-supporting level, and on which a cup-supporting plate 140 is seated, and an uppermost portion 150, which has a curved shape adapting the uppermost portion 150 to embrace a cup being held by the cupholder 100. Furthermore, the continuous wire 110 has two lower connecting portions 160, each of which connects one of the lowermost portions 120 to one of the intermediate portions 130, and two upper connecting portions 170, each of which connects one of the lowermost portions to the uppermost portion. The cup-supporting plate 140, which is an element of the cupholder 100, is welded or is mounted otherwise to the intermediate portions 130 of the continuous wire 110.

1. For a shopping cart having a basket, which has substantially vertical walls having a pattern or patterns of apertures, a combination comprising a cupholder and means for mounting the cupholder to the basket, wherein the mounting means comprises an outer mounting plate, which is positionable outside and against a given one of the basket walls, at a given one of the apertures, an inner mounting plate, which is positionable inside and against the same one of the basket walls, at the same one of the apertures, and a fastener, which is adapted to extend through the same one of the apertures, for fastening the outer and inner mounting plates, when so positioned, to each other, so as to mount the cupholder to the same one of the basket walls.

2. The combination of claim 1, wherein at least one of the outer and inner mounting plates is adapted to project, when so positioned, into the same one of the apertures.

3. The combination of claim 1, wherein at least one of the outer and inner mounting plates is adapted to fit snugly, when so positioned, into the same one of the apertures.

4. The combination of claim 1, wherein the outer mounting plate is adapted to project, when so positioned, into the same one of the apertures.

5. The combination of claim 1, wherein both mounting plates are adapted to project, when so positioned, into the same one of the apertures.

6. For a shopping cart having a basket, which has substantially vertical walls having a pattern or patterns of apertures defined by substantially horizontally extending and substantially vertically extending wires, a combination comprising a cupholder and means for mounting the cupholder to the basket, wherein the mounting means comprises an outer mounting plate, which is positionable outside and against a given one of the basket walls, at a given one of the apertures, an inner mounting plate, which is positionable inside and against the same one of the basket walls, at the same one of the apertures, and a fastener, which is adapted to extend through the same one of the apertures, for fastening the outer and inner mounting plates, when so positioned, to each other, so as to mount the cupholder to the same one of the basket walls.

7. The combination of claim 6, wherein at least one of the outer and inner mounting plates is adapted to project, when so positioned, into the same one of the apertures.

8. The combination of claim 6, wherein at least one of the outer and inner mounting plates is adapted to fit snugly, when so positioned, into the same one of the apertures.

9. The combination of claim 6, wherein the outer mounting plate is adapted to project, when so positioned, into the same one of the apertures.

10. The combination of claim 6, wherein both outer mounting plates are adapted to fit snugly, when so positioned, into the same one of the apertures.

11. The combination of claim 1, wherein the cupholder comprises a continuous wire having two lowermost portions, at which the continuous wire terminates and between and to which the one of the outer and inner mounting plates is mounted, two intermediate portions, which define a cup-supporting level, and an uppermost portion, which is shaped so as to embrace a cup being held by the cupholder.

12. The combination of claim 11, wherein the continuous wire has two lower connecting portions, each of which connects one of the lowermost portions to one of the intermediate portions, and two upper connecting portions, each of which connects one of the lowermost portions to the uppermost portion.

13. The combination of claim 11, wherein the cupholder comprises a cup-supporting plate, which is seated on the intermediate portions of the continuous wire.

14. The combination of claim 12, wherein the cupholder comprises a cup-supporting plate, which is seated on the intermediate portions of the continuous wire.

15. The combination of claim 1, wherein the cupholder comprises a continuous wire having two lowermost portions, at which the continuous wire terminates and between and to which the outer mounting plate is mounted, two intermediate portions, which define a cup-supporting level, and an uppermost portion, which is shaped so as to embrace a cup being held by the cupholder.

16. The combination of claim 15, wherein the continuous wire has two lower connecting portions, each of which connects one of the lowermost portions to one of the intermediate portions, and two upper connecting portions, each of which connects one of the intermediate portions to the uppermost portion.

17. The combination of claim 15, wherein the cupholder comprises a cup-supporting plate, which is seated on the intermediate portions of the continuous wire.

18. The combination of claim 16, wherein the cupholder comprises a cup-supporting plate, which is seated on the intermediate portions of the continuous wire.
